(19) United States
(12) Patent Application Publication
(10) Pub. No.: US 2021/0141758 A1
(43) Pub. Date: May 13, 2021

(54) FORMAT AGNOSTIC ENGINE FOR CUSTOMIZED FILE CREATION BASED ON VARIABLE DATA INJECTION

(71) Applicant: BANK OF AMERICA CORPORATION, Charlotte, NC (US)

(72) Inventors: Christopher Carroll, Seattle, WA (US); Karim A. Bouyoucef, Sunny Isles Beach, FL (US); Kenneth Cox, Cleveland, TN (US); Shaha Doddamani, Johns Creek, GA (US); Timmy L. Gauvin, Peachtree City, GA (US)

(73) Assignee: BANK OF AMERICA CORPORATION, Charlotte, NC (US)

(21) Appl. No.: 16/682,630

(22) Filed: Nov. 13, 2019

(51) Int. Cl. G06F 16/11; G06F 16/51; G06F 16/17; H04L 29/08

(52) U.S. Cl. CPC G06F 16/116; G06F 16/119; H04L 67/06; G06F 16/173; G06F 16/51

(57) ABSTRACT

A system for generating customized deliverable files based on variable data injection is provided. The system is configured to: receive a data retrieval request for image files stored in an image file database having an initial file format, the data retrieval request comprising construction specifications for a requesting entity device and a delivery endpoint; pull the image files from the image file database based on the data retrieval request; inject the image files and the construction specifications into a file construction engine configured to construct a merged file from the image files in a deliverable file format based on the construction specifications and the delivery endpoint; construct the merged file in the deliverable file format from the one or more image files based on the construction specifications and the delivery endpoint; and transport the merged file over a network to the delivery endpoint to complete the data retrieval request.

### BACKGROUND

The desire to migrate from mainframe systems to midrange systems in pursuit of increased scalability has led to the need for solutions for adapting existing applications and tasks to smaller scale hardware. Due to the heavy demand on computing resources, large-scale file processing, in particular the processing and delivery of image replacement documents, has typically been executed on mainframe-type systems. As such, there exists a need for an improved system for efficiently generating and delivering complex file packages outside of a mainframe-type system.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

A system for generating customized deliverable files based on variable data injection is provided. The system comprises: a memory device with computer-readable program code stored thereon; a communication device connected to a network; and a processing device, wherein the processing device is configured to execute the computer-readable program code to: receive a data retrieval request for one or more image files stored in an image file database having an initial file format, the data retrieval request comprising construction specifications for a requesting entity device and a delivery endpoint; pull the one or more image files from the image file database based on the data retrieval request; inject the one or more image files and the construction specifications into a file construction engine configured to construct a merged file from the one or more image files in a deliverable file format based on the construction specifications and the delivery endpoint; construct the merged file in the deliverable file format from the one or more image files based on the construction specifications and the delivery endpoint; and transport the merged file over the network to the delivery endpoint to complete the data retrieval request.

In a particular embodiment, the file construction engine is further configured to construct merged files in a plurality of customized deliverable file formats for a plurality of delivery endpoints based on the construction specifications injected into the file construction engine, wherein the plurality of customized deliverable file formats are generated from a format template configured for receiving the construction specifications, wherein the format template is transformed into at least one of the plurality of customized deliverable file formats upon receiving the construction specifications.

In another embodiment, the construction specifications and the delivery endpoint for the data retrieval request are stored in a record for the requesting entity device, wherein the processing device is further configured to execute the computer-readable program code to pull the record during subsequent data retrieval requests by the requesting entity device, wherein the record at least partially determines the construction specifications for the subsequent data retrieval requests. In yet another embodiment, the record is continuously updated based on completed data retrieval requests and, optionally, by the requesting entity device associated with the record.

In yet another embodiment, the system further comprises a request record component configured to assign tasks and inject data into the file construction engine for completion of the data retrieval request, wherein the request record component is configured to manage and store the construction specifications for a plurality of requesting entities. In yet another embodiment, the file construction engine is configured to pull the one or more image files from the image file database in response to receiving an assigned task from the request record component, wherein the request record component generates the assigned task based on the data retrieval request.

In yet another embodiment, the processing device is further configured to execute the computer-readable program code to map and route a delivery pathway based on the data retrieval request and the construction specifications for the requesting entity device to reduce a resource draw required for transporting the merged file to the delivery endpoint.

In yet another embodiment, the construction specifications comprise file format preferences and preferred file delivery routes for the entity device based on previous data retrieval requests.

In yet another embodiment, the system further comprises a midrange server, the midrange server including the image file database for providing the one or more image files to the file construction engine.

In yet another embodiment, the merged file is an image replacement document, the merged file comprising an image component comprising the one or more image files and a data component comprising information associated with each of the one or more image files.

In yet another embodiment, the processing device is further configured to execute the computer-readable program code to transmit an acknowledgement file with the merged file to the delivery endpoint, wherein the acknowledgement file is configured to be transmitted back by the delivery endpoint based on successful delivery of the merged file.

A computer program product for generating customized deliverable files based on variable data injection is also provided. The computer program product comprises a non-transitory computer-readable medium comprising computer-readable instructions, the computer-readable instructions, when executed by a processing device, cause the processing device to: receive a data retrieval request for one or more image files stored in an image file database having an initial file format, the data retrieval request comprising construction specifications for a requesting entity device and a delivery endpoint; pull the one or more image files from the image file database based on the data retrieval request; inject the one or more image files and the construction specifications into a file construction engine configured to construct a merged file from the one or more image files in a deliverable file format based on the construction specifications and the delivery endpoint; construct the merged file in the deliverable file format from the one or more image files based on the construction specifications and the delivery endpoint; and transport the merged file over a network to the delivery endpoint to complete the data retrieval request.

In a particular embodiment, the file construction engine is further configured to construct merged files in a plurality of customized deliverable file formats for a plurality of delivery endpoints based on the construction specifications injected into the file construction engine, wherein the plurality of customized deliverable file formats are generated from a format template configured for receiving the construction specifications, wherein the format template is transformed into at least one of the plurality of customized deliverable file formats upon receiving the construction specifications.

In another embodiment, the construction specifications and the delivery endpoint for the data retrieval request are stored in a record for the requesting entity device, wherein the processing device is further configured to execute the computer-readable instructions to pull the record during subsequent data retrieval requests by the requesting entity device, wherein the record at least partially determines the construction specifications for the subsequent data retrieval requests. In yet another embodiment, the record is continuously updated based on completed data retrieval requests and, optionally, by the requesting entity device associated with the record.

In yet another embodiment, the computer program product further comprises a request record component configured to assign tasks and inject data into the file construction engine for completion of the data retrieval request, wherein the request record component is configured to manage and store the construction specifications for a plurality of requesting entities. In yet another embodiment, the file construction engine is configured to pull the one or more image files from the image file database in response to receiving an assigned task from the request record component, wherein the request record component generates the assigned task based on the data retrieval request.

In yet another embodiment, the processing device is further configured to execute the computer-readable instructions to map and route a delivery pathway based on the data retrieval request and the construction specifications for the requesting entity device to reduce a resource draw required for transporting the merged file to the delivery endpoint.

In yet another embodiment, the construction specifications comprise file format preferences and preferred file delivery routes for the entity device based on previous data retrieval requests.

A computer-implemented method for generating customized deliverable files based on variable data injection is also provided. The computer-implemented method comprising: receiving a data retrieval request for one or more image files stored in an image file database having an initial file format, the data retrieval request comprising construction specifications for a requesting entity device and a delivery endpoint; pulling the one or more image files from the image file database based on the data retrieval request; injecting the one or more image files and the construction specifications into a file construction engine configured to construct a merged file from the one or more image files in a deliverable file format based on the construction specifications and the delivery endpoint; constructing the merged file in the deliverable file format from the one or more image files based on the construction specifications and the delivery endpoint; and transporting the merged file over a network to the delivery endpoint to complete the data retrieval request.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a customized file format construction system environment, in accordance with one embodiment of the invention;

FIG. 2 provides a block diagram of a user device, in accordance with one embodiment of the invention;

FIG. 3 provides a block diagram of a customized file generator, in accordance with one embodiment of the invention;

FIG. 4 provides a block diagram of an entity system, in accordance with one embodiment of the invention;

FIG. 5 provides a block diagram of a third party system, in accordance with one embodiment of the invention;

FIG. 6 provides a high level block diagram of a mainframe system environment configured for customized file construction;

FIG. 7 provides a high level block diagram of a midrange system environment configured for customized file construction, in accordance with one embodiment of the invention; and

FIG. 8 provides a high level process flow for generating customized deliverable files based on variable data injection, in accordance with one embodiment of the invention.

### DETAILED DESCRIPTION OF EMBODIMENTS OF THE INVENTION

Embodiments of the invention, as described herein, leverage complex, specific-use computer system to provide a novel approach for generating and delivering custom-formatted file types, and in particular, those files requiring customized image file formats. The system of the present invention is configured to generate and delivery a tailored file package to a user-specified location, such as a device, system, server, or other network endpoint, based on a received data retrieval request. The system generates and stores records for providing construction specifications to a file generator engine that constructs newly formatted files for delivery.

Conventional systems that process and deliver files such as image replacement documents to a number of entities typically generate new file types for each unique, requested file. As various entities can have greatly differing internal or regulatory requirements for file processing and formatting, this can lead to a large number of different file formats that need to be generated and stored by a file processing system. For example, even seemingly small differences between file formats may require complete versions of each different type of file format to be stored. Alternatively, the present invention provides a non-conventional solution to this technological problem. The present invention instead stores all entity information, data, and file formatting specifications and requirements upstream of a file construction engine. As requests are received, this stored information is selectively injected into the file construction engine based on the requirements of individual data retrieval requests. By starting with a shared template, the file construction engine is configured to generate a custom-formatted file type without needing to generate a new file format from the ground up. In this way, the system reduces an amount of computing resources required for processing new requests thereby improving the operation and efficiency of the computer hardware components involved while simultaneously reducing file construction time.

The present invention further provides a solution to the technological problem arising from migrating a large-scale, image file generator to a midrange system or midrange server environment. Typically, due to the heavy demand on computing resources, large-scale file processing, in particular the processing and delivery of image replacement documents, is executed on mainframe-type systems. While a direct translation of a typical file processing and delivery system to a midrange environment could not support the same volume of requested file transfer tasks, the non-conventional arrangement and interdependence of the specialized file construction engine and the record-driven, task assignment component allows for efficient operation on midrange systems. Furthermore, by allowing for operation in a midrange system environment, scalability of the process may be improved.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

As used herein, the term “computing resource” or “resource” may refer to elements of one or more computing devices, networks, or the like available to be used in the execution of tasks or processes. A computing resource may be used to refer to available processing, memory, and/or network bandwidth and/or power of an individual computing device as well a plurality of computing devices that may operate as a collective for the execution of one or more tasks (e.g., one or more computing devices operating in unison).

As used herein, the term “user” may refer to any entity or individual associated with the customized file format construction system. In some embodiments, a user may be a computing device user, a phone user, a mobile device application user, a customer of an entity or business, a system operator, and/or employee of an entity (e.g., a financial institution). In one embodiment, a user may be a merchant or business owner who is a customer of a software providing entity. In a specific embodiment, a user is an entity requesting delivery of one or more image files in a specific image file format. In another embodiment, a user may be an employee of an entity that provides a file processing and delivery to other users or entities. In some embodiments, identities of an individual may further include online handles, usernames, identification numbers (e.g., Internet protocol (IP) addresses), aliases, family names, maiden names, nicknames, or the like. In some embodiments, the user may be an individual or an organization (i.e., a charity, business, company, governing body, or the like).

As used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), a mobile Internet accessing device, or other mobile device. Other types of mobile devices may include laptop computers, tablet computers, wearable devices, cameras, video recorders, audio/video player, radio, global positioning system (GPS) devices, portable digital assistants (PDAs), pagers, mobile televisions, gaming devices, automated teller machines (ATMs), or any combination of the aforementioned. The device may be used by the user to access the system directly or through an application, online portal, internet browser, virtual private network, or other connection channel. In a specific embodiment, a user device may comprise a terminal or endpoint used to place a data retrieval request to the system.

As used herein, the term “entity” may be used to include any organization or collection of users that may interact with the customized file format construction system. An entity may refer to a business, company, or other organization that either maintains or operates the system or requests use and/or accesses the system. In one embodiment, the entity may be a software development entity or data management entity. In a specific embodiment, the entity may be or may be associated with a financial institution, wherein the entity develops and/or provides software to other users and entities such as merchants as a service. The terms “financial institution” and “financial entity” may be used to include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, a government organization or the like that is not a financial institution.

To “monitor” is to watch, observe, or check something for a special purpose over a period of time. The “monitoring” may occur periodically over the period of time, or the monitoring may occur continuously over the period of time. In some embodiments, a system may actively monitor a data source, data stream, database, or data archive, wherein the system may be configured to reach out to the data source and watch, observe, or check the data source for changes, updates, variations, patterns, and the like. In other embodiments, a system may passively monitor a data source or data stream, wherein the data source or data stream provides information to the system and the system then watches, observes, or checks the provided information. In some embodiments, “monitoring” may further comprise analyzing or performing a process on something such as a data source or data stream either passively or in response to an action or change in the data source or data stream.

As used herein, an “interaction” may refer to any action or communication between one or more users, one or more entities or institutions, and/or one or more devices or systems within the system environment described herein. For example, an interaction may refer to a user interaction with a system or device, wherein the user interacts with the system or device in a particular way. In one embodiment, interactions may be received or extracted from a data stream (e.g., in real-time). An interaction may include user interactions with a user interface of a user application (e.g., clicking, swiping, drag-and-drop, toggling, text or data entry, etc.), authentication actions (e.g., signing-in, username and password entry, PIN entry, etc.), account actions or events (e.g., account access, fund transfers, document or record views, etc.) and the like. In another example, an interaction may refer to a user communication via one or more channels (i.e., phone, email, text, instant messaging, brick-and-mortar interaction, and the like) with an entity and/or entity system to complete an operation or perform an action with an account associated with user and/or the entity. In a specific embodiment, an interaction may comprise a transaction, exchange, or transmission of resources (e.g., funds or data (i.e., files)) between devices either directly or via an intermediate system (e.g., an entity system and/or the customized file format construction system described below). In another specific embodiment, an interaction may comprise a request for retrieval and/or delivery of one or more files such as one or more image replacement documents.

FIG. 1 provides a customized file format construction system environment 100, in accordance with one embodiment of the invention. As illustrated in FIG. 1, customized file format generator 130 is operatively coupled, via a network 101, to the user device(s) 110 (e.g., a plurality of user devices 110a-110d), the entity system(s) 120, and third party system(s) 140. In this way, the customized file format construction system 130 can send information to and receive information from the user device 110, the entity system 120 and the third party system 140. In the illustrated embodiment, the plurality of user devices 110a-110d provide a plurality of communication channels through which the entity system 120, third party system 140, and/or the customized file format construction system 130 may communicate with the user 102 over the network 101.

FIG. 1 illustrates only one example of an embodiment of the system environment 100. It will be appreciated that in other embodiments, one or more of the systems, devices, or servers may be combined into a single system, device, or server, or be made up of multiple systems, devices, or servers. It should be understood that the servers, systems, and devices described herein illustrate one embodiment of the invention. It is further understood that one or more of the servers, systems, and devices can be combined in other embodiments and still function in the same or similar way as the embodiments described herein.

The network 101 may be a system specific distributive network receiving and distributing specific network feeds and identifying specific network associated triggers. The network 101 may also be a global area network (GAN), such as the Internet, a wide area network (WAN), a local area network (LAN), or any other type of network or combination of networks. The network 101 may provide for wireline, wireless, or a combination wireline and wireless communication between devices on the network 101.

In some embodiments, the user 102 is an individual interacting with one or more entity systems 120, third party systems 140, and/or other user devices via a user device 110 while a data stream or flow between the user device 110 and the entity system 120 and/or other user devices is intercepted and monitored by the customized file format construction system 130 over the network 101. In some embodiments a user 102 is a user requesting service from the entity or interacting with an account maintained by the entity system 120. In an alternative embodiment, the user 102 is an individual interacting with the customized file format construction system 130 over the network 101 and monitoring input of information from the entity systems 120 and/or third party systems 140 to and from the customized file format construction system 130 for processing and analysis (e.g., an employee of the entity operating and/or monitoring the systems 120, 130). In an alternative example, the interaction may be processed through another system such as entity system 120 and/or customized file format construction system 130. In one embodiment, the user 102 is an entity or individual requesting processing and delivery of one or more image replacement documents via the customized file format construction system 130.

FIG. 2 provides a block diagram of a user device 110, in accordance with one embodiment of the invention. The user device 110 may generally include a processing device or processor 202 communicably coupled to devices such as, a memory device 234, user output devices 218 (e.g., a user display device 220, or a speaker 222), user input devices 214 (e.g., a microphone, keypad, touchpad, touch screen, and the like), a communication device or network interface device 224, a power source 244, a clock or other timer 246, a visual capture device such as a camera 216, a positioning system device 242, such as a geo-positioning system device like a GPS device, an accelerometer, and the like. In one embodiment, the camera 216 may include a scanner, barcode reader, or any other image capturing device or sensor configured to capture an image. The processing device 202 may further include a central processing unit 204, input/output (I/O) port controllers 206, a graphics controller or graphics processing device (GPU) 208, a serial bus controller 210 and a memory and local bus controller 212.

The processing device 202 may include functionality to operate one or more software programs or applications, which may be stored in the memory device 234. For example, the processing device 202 may be capable of operating applications such as the user application 238. The user application 238 may then allow the user device 110 to transmit and receive data and instructions from the other devices and systems of the environment 100. The user device 110 comprises computer-readable instructions 236 and data storage 240 stored in the memory device 234, which in one embodiment includes the computer-readable instructions 236 of a user application 238. In some embodiments, the user application 238 allows a user 102 to access and/or interact with other systems such as the entity system 120, customized file format construction system 130, and/or third party system 140. In one embodiment, the user application 238 may be configured to allow a user 102 to request, initiate, and/or receive an interaction with another device or system. In some embodiments, a user application 238 may be configured to allow a user to interact with the customized file format construction system 130 to request one or more files (e.g., image files or image replacement documents) stored in or for delivery to the entity systems 120 and/or one or more of the third party systems 140.

The processing device 202 may be configured to use the communication device 224 to communicate with one or more other devices on a network 101 such as, but not limited to the entity system 120 and the customized file format construction system 130. In this regard, the communication device 224 may include an antenna 226 operatively coupled to a transmitter 228 and a receiver 230 (together a “transceiver”), modem 232. The processing device 202 may be configured to provide signals to and receive signals from the transmitter 228 and receiver 230, respectively. The signals may include signaling information in accordance with the air interface standard of the applicable BLE standard, cellular system of the wireless telephone network and the like, that may be part of the network 201. In this regard, the user device 110 may be configured to operate with one or more air interface standards, communication protocols, modulation types, and access types. By way of illustration, the user device 110 may be configured to operate in accordance with any of a number of first, second, third, and/or fourth-generation communication protocols and/or the like. For example, the user device 110 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 110 may also be configured to operate in accordance with non-cellular communication mechanisms, such as via a wireless local area network (WLAN) or other communication/data networks. The user device 110 may also be configured to operate in accordance Bluetooth® low energy, audio frequency, ultrasound frequency, or other communication/data networks.

The user device 110 may also include a memory buffer, cache memory or temporary memory device operatively coupled to the processing device 202. Typically, the one or more applications 238 are loaded into the temporary memory during use. As used herein, memory may include any computer readable medium configured to store data, code, or other information. The memory device 234 may include volatile memory, such as volatile Random Access Memory (RAM) including a cache area for the temporary storage of data. The memory device 234 may also include non-volatile memory, which can be embedded and/or may be removable. The non-volatile memory may additionally or alternatively include an electrically erasable programmable read-only memory (EEPROM), flash memory or the like.

FIG. 3 provides a block diagram of a customized file format construction system 130, in accordance with one embodiment of the invention. The customized file format construction system 130 generally comprises a controller 301, a communication device 302, a processing device 304, and a memory device 306.

As used herein, the term “controller” generally refers to a hardware device and/or software program that controls and manages the various systems described herein such as the user device 110, the entity system 120, the third party system 140, and/or the customized file format construction system 130, in order to interface and manage data flow between systems while executing commands to control the systems. In some embodiments, the controller 301 may be integrated into or be placed in one or more of the systems described herein. In other embodiments, the controller 301 may be a separate system or device. In some embodiments, the controller 301 may perform one or more of the processes, actions, or commands described herein.

As used herein, the term “processing device” or “processor” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 304 is operatively coupled to the communication device 302 and the memory device 306. The processing device 304 uses the communication device 302 to communicate with the network 101 and other devices on the network 101, such as, but not limited to the user device 110, the entity system 120, and the third party system 140. As such, the communication device 302 generally comprises a modem, server, or other device for communicating with other devices on the network 101.

As further illustrated in FIG. 3, the customized file format construction system 130 comprises computer-readable instructions 310 stored in the memory device 306, which in one embodiment includes the computer-readable instructions 310 of a file construction engine 312 and a request record module or application 314. The file construction engine 312 may be configured to pull one or more files (e.g., image files) from a file database and construct a merged file in a customized file format. The file construction engine 312 may be further configured to deliver or transport a file to a network endpoint or other device. The request record module 314 may be configured to assign tasks and inject data (e.g., construction specifications and records) into the file construction engine 312 for completion of a data retrieval request.

In some embodiments, the memory device 306 includes data storage 308 for storing data related to the system environment, but not limited to data created and/or used by the file construction engine 312 and the request record module 314. Data stored in the data storage 308 may comprise one or records 316 and historical interaction data 322. The one or more records 316 further comprise construction specification data 318 and user and/or entity data storage 320. The records 316 and their contents may be used to determine data that is injected into the file construction engine 312 in response to receiving a data retrieval request. For example, construction specification 318 outlining preferences and/or requirements for file construction and delivery for a specific entity or system may be provided to the file construction engine 312 to determine how a file generated by the file construction engine 312 should be formatted along with any conditions for its delivery (e.g., scheduling, routing, endpoints, etc.). The user and/or entity data storage 320 may include previously generated file formats and conditions for users and/or entities in past interactions. The historical interaction data 322 includes a collection of previous interactions with reference to associated records stored in the system.

In one embodiment of the invention, the customized file format construction system 130 may associate with applications having computer-executable program code that instruct the processing device 304 to perform certain functions described herein. In one embodiment, the computer-executable program code of an application associated with the user device 110 and/or the entity systems 120 may also instruct the processing device 304 to perform certain logic, data processing, and data storing functions of the application.

Embodiments of the customized file format construction system 130 may include multiple systems, servers, computers or the like maintained by one or many entities. In some embodiments, the customized file format construction system 130 may be part of the entity systems 120. In other embodiments, the entity systems 120 are distinct from the customized file format construction system 130. The customized file format construction system 130 may communicate with the entity systems 120 via a secure connection generated for secure encrypted communications between the two systems either over the network 101 or alternative to the network 101.

As illustrated in detail in FIG. 4, the environment 100 further includes one or more entity systems 120 which are connected to the user device 110 and the customized file format construction system 130. The entity systems 120 may be associated with one or more entities, institutions or the like, such as an entity maintaining the customized file format construction system 130. The entity systems 120 generally comprise a communication device 402, a processing device 404, and a memory device 406 further comprising data storage 408. The entity systems 120 comprise computer-readable instructions 410 stored in the memory device 406, which in one embodiment includes the computer-readable instructions of an entity application 412. The entity systems 120 may communicate with the user device 110 and the application construction system 130 to provide access to accounts, resources, data (e.g., entity records 414) stored and maintained on the entity systems 120. In some embodiments, the entity system 120 may communicate with the customized file format construction system 130 during an interaction with a user 102 in real-time, wherein user interactions may be monitored and processed by the customized file format construction system 130. In some embodiments, data storage 408 comprises entity records 414 to either supplement or replace similar data storages or databases on the customized file format construction system 130 as previously discussed.

As illustrated in detail in FIG. 5, the environment 100 further includes one or more third party systems 140 which are connected to the user device 110, entity systems 120, and the customized file format construction system 130. The third party systems 140 may be associated with one or more users or customers of the customized file format construction system 130. The third party systems 140 generally comprise a communication device 502, a processing device 504, and a memory device 506 further comprising data storage 508. The third party systems 140 comprise computer-readable instructions 510 stored in the memory device 506, which in one embodiment includes the computer-readable instructions of a third party application 512. The third party systems 140 may communicate with the user device 110, entity systems 120, and the customized file format construction system 130 to provide access to accounts, resources, data (e.g., third party data 514) stored and maintained on the third party systems 140. In some embodiments, the third party system 140 may communicate with the customized file format construction system 130 during an interaction with a user 102 in real-time, wherein user interactions may be monitored and processed by the customized file format construction system 130.

The systems of the environment 100 may be used to generate and deliver custom-formatted file types, and in particular, those files requiring customized image file formats. As previously discussed, the system of the present invention is configured to generate and deliver a tailored file package to a user-specified location, such as a device, system, server, or other network endpoint, based on a received data retrieval request. The system generates and stores records for providing construction specifications to a file construction engine. The present invention stores all entity information, data, and file formatting specifications and requirements upstream of the file construction engine. As data retrieval requests are received, this information is selectively injected into the file construction engine based on the requirements of individual requests. Starting with a template, the file construction engine is configured to generate a custom-formatted file type without needing to generate a new file format from the ground up. In this way, the system reduces an amount of computing resources required for processing new requests thereby improving the operation and efficiency of the computer hardware components involved while simultaneously reducing file construction time. Alternatively, conventional systems that process and deliver files such as image replacement documents to a number of entities typically generate new file types for each unique requested file. As various entities can have greatly differing internal or regulatory requirements, this can lead to a large number of different file formats that need to be generated and stored by a system. For example, even seemingly small differences between formats would typically require complete versions of each type of file format to be stored by the system. The present invention provides a non-conventional solution to this technological problem.

FIG. 6 provides a high level block diagram of a mainframe system environment configured for file delivery. Typically, due to the heavy demand on computing resources, large-scale file processing, and in particular the processing and delivery of image replacement documents, is executed on mainframe-type systems. A mainframe may be a large server, database, and/or computing system designed for processing and storing large amounts of data. As seen in FIG. 6, batched files are requested and sent from a mainframe system 602 to a file collection and routing system 604. The file collection and routing system 604 is then configured to directly distribute and deliver collected files to one or more endpoints or terminal systems 606A-C.

That said, the present invention is preferably implemented on a midrange system instead of a conventional mainframe system. A midrange system, as described herein, may comprise a server, database, computing device, and/or series of computing devices having a processing power generally less than that of a mainframe system but still capable of large-scale data processing. In addition to having more modern system architecture than their mainframe counterparts, midrange systems further offer more easily accessible scalability and expandability for enhanced potential performance. FIG. 7 provides a high level block diagram of a midrange system environment configured for customized file construction. Within the system 700, file retrieval requests are sent from a file collection and routing system 707 to a file construction engine 706, wherein the request is processed through a record-driven, task assignment component 704. The record-driven, task assignment component 704 is in communication with a record storage database 702 for storing entity and/or user record generated and updated by the system during interactions. The record-driven component or module 704 is configured to direct the file construction engine 706, via transmitted instruction, to pull files associated with the received request from a file database 705 and inject the instructions and construction specifications of the request into a file construction engine 706. In response, the file construction engine 706 pulls the requested files from the file database 705. A file package is then constructed and formatted before being delivered to one or more endpoints or terminal systems 708A-C. By using the intermediate processing abilities of the file construction engine and the record-driven, task assignment component 704 as further described herein, the system is able to process large volumes of file requests (e.g. 1000s of images per second) that would normally not be possible without a mainframe system.

FIG. 8 provides a high level process flow for generating customized deliverable files based on variable data injection, in accordance with one embodiment of the invention. As illustrated in block 810, the system is configured to first receive a data retrieval request for one or more files stored in a file database. The data retrieval request may comprise a transmitted command, instructions, message, or the like for retrieving, processing, and delivering one or more specified files. A data retrieval request may be sent to the system from another system such as a third party or other entity system (e.g., an entity, user, client). In another embodiment, the request may be transmitted internally by an entity maintaining and operating the file construction system.

The data retrieval request may further comprise one or more construction specifications or conditions for processing and delivering the requested files. In some embodiments, the construction specifications may comprise file format preferences and preferred file delivery routes to an endpoint. For example, while the requested files stored by the system have an initial file format, a request may include instructions for transforming the stored files into a new compatible format to enable delivery to a specific system or device. The construction specifications may further specify one or more destinations or endpoints in the network for delivery of the one or more files exported by the system.

In some embodiments, the system may be configured to construct and store records for entities or users requesting file processing and delivery. The requesting entity records may comprise the construction specifications, endpoints, and other specified information contained in previous requests or interactions between the requesting entity and the system. In some embodiments, the system may be configured to pull constructed entity records during subsequent data retrieval requests by the entity, wherein the system may automatically determine and populate construction specifications for the subsequent entity requests based on the record content. The system may be configured to continuously update records based on completed data retrieval requests leading to progressively faster processing of subsequent interactions or requests with repeat entities. Optionally, the system may be configured to provide records to the associated requesting entity to allow for the requesting entity to update and maintain the preferences. In one embodiment, records may be at least partially stored and maintained on an entity system associated with a requesting entity.

In some embodiments, the system may comprise a request record component (i.e., component 704 of FIG. 7) configured to assign tasks and inject data into the file construction engine for completion of a data retrieval request. The request record component or module may be configured to perform the steps previously described herein with respect to pulling, maintaining, and updating user records. In some embodiments, the request record component is configured to manage and store the construction specifications for a plurality of requesting entities in the system.

The system is configured to receive and use the contents of the data retrieval request to at least partially direct a file construction and delivery. In response to receiving the data retrieval request, at block 820, the system pulls the one or more files (e.g., the construction specifications and the records) from the database (i.e., record storage database 702 of FIG. 7) based on the data retrieval request. In some embodiments, the request record component may be configured to generate and assign one or more tasks for execution by the system based on the data retrieval request. For example, the system may be configured to pull one or more files based on a task assigned from the request record component.

While it should be understood that any type of file may be processed by the system described herein, in some embodiments, the files may be image files having one or more image file formats. In a specific embodiment, the files may comprise one or more images of documents such as checks. In this specific embodiment, the system may be configured for processing these document images into a new format such as an image replacement document format, image letter format, image cash letter format, or the like. In this embodiment, the new file format is a merged file format, wherein the image files are transformed into a deliverable file format tailored for a delivery endpoint system or device.

At block 830, the system injects the one or more files requested by the requesting user or entity into a file construction engine configured to construct a merged file from the injected files, wherein the merged file comprises the one or more requested files in a new file format enabling delivery to an endpoint system. In some embodiments, the construction specifications for the data retrieval request are injected into the file construction engine with the requested images. In some embodiments, the file construction engine receive instructions for pulling one or more files from a file database (e.g., image file database 705 of FIG. 7) form the record-driven component.

The present invention stores all entity information, data, and file formatting specifications and requirements, requested images, and the like upstream of the file construction engine. As data retrieval requests are received, information is selectively injected by the record-driven component into the file construction engine based on the requirements of the individual requests. Using the injected information, the file construction engine is configured to generate a custom-formatted file type without needing to generate a new file format from the ground up. The file construction engine may instead, in some embodiments, start from a template that may be populated with the injected information and tailored to fit individual requests.

In one embodiment, the data retrieval request comprises a file drop component and a trigger file component. The file drop component may comprise the one or more files pulled from the database by the system. The file drop component may further include executable code portions configured to perform one or more assigned tasks such as one or more tasks for constructing a new file format based on constructions specifications. The trigger file component may comprise a relatively small control file used to initiate the one or more tasks when injected into the file construction engine.

At block 840, the system constructs merged file from the one or more files injected into the file construction engine. The merged file has a new file format different than the initial file format of the one of more files. In some embodiments, the new file format is a file format that is compatible with an endpoint system, wherein transforming the one or more files into the merged file format enables delivery of the files to the endpoint. In another embodiment, the new file format is file format conducive to delivery over a network. In a specific example, the one or more files may be one or more image files of documents such as checks. The one or more image files may be transformed from a first image file format to a merged image file format such as an image replacement document format or the like. The merged image file format may be a deliverable file format that allows for delivery and processing of the merged image file by a requesting entity system, endpoint, device, or the like. In some embodiments, a merged image file format may be specified in the construction specifications associated with a requesting entity, wherein the file construction engine may generate a merged file in a preferred or compatible file format for the requesting entity.

In some embodiments, the system may be configured to construct merged files in a plurality of customized deliverable file formats for a plurality of delivery endpoints based on the construction specifications injected into the file construction engine. The plurality of customized deliverable file formats may be generated from a format template configured for receiving the construction specifications, wherein the format template is transformed into at least one of the plurality of customized deliverable file formats upon receiving the construction specifications at the file construction engine.

At block 850, the system transports the merged file over the network to a delivery endpoint to complete the data retrieval request, wherein the requested files in the new merged file format are delivered to the endpoint according to the required conditions of the construction specifications and records. In some embodiments, the system may be configured to map and/or route a network delivery pathway based on the data retrieval request and the construction specifications. The system may be configured to route a delivery of one or more files through one or more different systems or devices over the network based on the requirements of the request. Similarly, the system may be configured to delivery the requested files to one or more endpoints. In a specific example, the system may be instructed by the requirements of the request to reduce a resource draw required for transporting the merged file to a delivery endpoint through a specific network routing pathway. In some embodiments, the system may be configured to schedule file delivery to one or more endpoints at predetermined times.

In some embodiments, the system may be configured to transmit an acknowledgement file with a merged file to the delivery endpoint, wherein the acknowledgement file is configured to be transmitted back by the delivery endpoint to the system based on successful delivery of the merged file. In this way, the system may confirm delivery and receipt of the merged file to the endpoint. In one embodiment, the acknowledgement file is an executable file that is configured to be automatically transmitted back to the system based on the merged file being delivered to the endpoint.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with generating and delivering custom-formatted file types.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for generating and delivering custom-formatted file types, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for generating customized deliverable files based on variable data injection, the system comprising:
a memory device with computer-readable program code stored thereon;
a communication device connected to a network; and
a processing device, wherein the processing device is configured to execute the computer-readable program code to:
receive a data retrieval request for one or more image files stored in an image file database having an initial file format, the data retrieval request comprising construction specifications for a requesting entity device and a delivery endpoint;
pull the one or more image files from the image file database based on the data retrieval request;
inject the one or more image files and the construction specifications into a file construction engine configured to construct a merged file from the one or more image files in a deliverable file format based on the construction specifications and the delivery endpoint;
construct the merged file in the deliverable file format from the one or more image files based on the construction specifications and the delivery endpoint; and
transport the merged file over the network to the delivery endpoint to complete the data retrieval request.

2. The system of claim 1, wherein the file construction engine is further configured to construct merged files in a plurality of customized deliverable file formats for a plurality of delivery endpoints based on the construction specifications injected into the file construction engine, wherein the plurality of customized deliverable file formats are generated from a format template configured for receiving the construction specifications, wherein the format template is transformed into at least one of the plurality of customized deliverable file formats upon receiving the construction specifications.

3. The system of claim 1, wherein the construction specifications and the delivery endpoint for the data retrieval request are stored in a record for the requesting entity device, wherein the processing device is further configured to execute the computer-readable program code to pull the record during subsequent data retrieval requests by the requesting entity device, wherein the record at least partially determines the construction specifications for the subsequent data retrieval requests.

4. The system of claim 3, wherein the record is continuously updated based on completed data retrieval requests and, optionally, by the requesting entity device associated with the record.

5. The system of claim 1 further comprising a request record component configured to assign tasks and inject data into the file construction engine for completion of the data retrieval request, wherein the request record component is configured to manage and store the construction specifications for a plurality of requesting entities.

6. The system of claim 5, wherein the file construction engine is configured to pull the one or more image files from the image file database in response to receiving an assigned task from the request record component, wherein the request record component generates the assigned task based on the data retrieval request.

7. The system of claim 1, wherein the processing device is further configured to execute the computer-readable program code to map and route a delivery pathway based on the data retrieval request and the construction specifications for the requesting entity device to reduce a resource draw required for transporting the merged file to the delivery endpoint.

8. The system of claim 1, wherein the construction specifications comprise file format preferences and preferred file delivery routes for the requesting entity device based on previous data retrieval requests.

9. The system of claim 1 further comprising a midrange server, the midrange server including the image file database for providing the one or more image files to the file construction engine.

10. The system of claim 1, wherein the merged file is an image replacement document, the merged file comprising an image component comprising the one or more image files and a data component comprising information associated with each of the one or more image files.

11. The system of claim 1, wherein the processing device is further configured to execute the computer-readable program code to transmit an acknowledgement file with the merged file to the delivery endpoint, wherein the acknowledgement file is configured to be transmitted back by the delivery endpoint based on successful delivery of the merged file.

12. A computer program product for generating customized deliverable files based on variable data injection, wherein the computer program product comprises a non-transitory computer-readable medium comprising computer-readable instructions, the computer-readable instructions, when executed by a processing device, cause the processing device to:
receive a data retrieval request for one or more image files stored in an image file database having an initial file format, the data retrieval request comprising construction specifications for a requesting entity device and a delivery endpoint;
pull the one or more image files from the image file database based on the data retrieval request;
inject the one or more image files and the construction specifications into a file construction engine configured to construct a merged file from the one or more image files in a deliverable file format based on the construction specifications and the delivery endpoint;
construct the merged file in the deliverable file format from the one or more image files based on the construction specifications and the delivery endpoint; and
transport the merged file over a network to the delivery endpoint to complete the data retrieval request.

13. The computer program product of claim 12, wherein the file construction engine is further configured to construct merged files in a plurality of customized deliverable file formats for a plurality of delivery endpoints based on the construction specifications injected into the file construction engine, wherein the plurality of customized deliverable file formats are generated from a format template configured for receiving the construction specifications, wherein the format template is transformed into at least one of the plurality of customized deliverable file formats upon receiving the construction specifications.

14. The computer program product of claim 12, wherein the construction specifications and the delivery endpoint for the data retrieval request are stored in a record for the requesting entity device, wherein the processing device is further configured to execute the computer-readable instructions to pull the record during subsequent data retrieval requests by the requesting entity device, wherein the record at least partially determines the construction specifications for the subsequent data retrieval requests.

15. The computer program product of claim 14, wherein the record is continuously updated based on completed data retrieval requests and, optionally, by the requesting entity device associated with the record.

16. The computer program product of claim 12 further comprising a request record component configured to assign tasks and inject data into the file construction engine for completion of the data retrieval request, wherein the request record component is configured to manage and store the construction specifications for a plurality of requesting entities.

17. The computer program product of claim 16, wherein the file construction engine is configured to pull the one or more image files from the image file database in response to receiving an assigned task from the request record component, wherein the request record component generates the assigned task based on the data retrieval request.

18. The computer program product of claim 12, wherein the processing device is further configured to execute the computer-readable instructions to map and route a delivery pathway based on the data retrieval request and the construction specifications for the requesting entity device to reduce a resource draw required for transporting the merged file to the delivery endpoint.

19. The computer program product of claim 12, wherein the construction specifications comprise file format preferences and preferred file delivery routes for the requesting entity device based on previous data retrieval requests.

20. A computer-implemented method for generating customized deliverable files based on variable data injection, the computer-implemented method comprising:
receiving a data retrieval request for one or more image files stored in an image file database having an initial file format, the data retrieval request comprising construction specifications for a requesting entity device and a delivery endpoint;
pulling the one or more image files from the image file database based on the data retrieval request;
injecting the one or more image files and the construction specifications into a file construction engine configured to construct a merged file from the one or more image files in a deliverable file format based on the construction specifications and the delivery endpoint;
constructing the merged file in the deliverable file format from the one or more image files based on the construction specifications and the delivery endpoint; and
transporting the merged file over a network to the delivery endpoint to complete the data retrieval request.
